(19) United States
(12) Patent Application Publication
(10) Pub. No.: US 2010/0114942 A1
(43) Pub. Date: May 6, 2010

(54) METHOD AND SYSTEM FOR PROVIDING A PERSONALIZED SCHEDULE BASED ON CALENDARING ENTRIES

(76) Inventor: Yoram Nelken, San Francisco, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/613,867

(22) Filed: Nov. 6, 2009

Related U.S. Application Data
(60) Provisional application No. 61/112,125, filed on Nov. 6, 2008.

(51) Int. Cl. G06F 17/30

(52) U.S. Cl. 707/769; 707/781; 707/E17.108; 707/E17.005

(57) ABSTRACT

In a method for providing a personalized schedule based on calendaring entries, a request is sent to retrieve data for a calendaring entry using a connector and the connector has instructions to permit access to data for a calendaring module and the data for the calendaring module being stored on at least one of local storage of a first remote computer system and storage at a second remote computer system, data is received for the calendaring entry, one or more descriptors are determined from data for the calendaring entry, a database is queried with a query request using at least one of the one or more descriptors, a query result is received for the query request, and the query result is associated with the calendaring entry in a personalized schedule.

### RELATED APPLICATIONS

This application is a NONPROVISIONAL of and claims priority to, U.S. Provisional Patent Application 61/112,125, filed 6 Nov. 2008, incorporated herein by reference.

### FIELD OF THE INVENTION

The present invention is related to methods and systems for providing personalized schedules based on calendaring entries.

### BACKGROUND

A calendaring software application is one that allows a user to schedule events or meetings, and display the information in an organized fashion in a schedule. A schedule may span any amount of time, such as a day, a week, a month or a year, and may have one or more entries for meetings or events at designated times and dates. Sometimes, meeting participants and a meeting location associated with the calendaring entry may be used to describe an event or meeting. Calendaring software applications may also provide functionality to alert to a user that a meeting time is approaching for an event designated in a calendar entry.

### SUMMARY OF THE INVENTION

The present invention facilitates the providing of a personalized schedule based on calendaring entries. In one embodiment of the invention, a request is sent (for example from a client application running on a first computer system to a server or other computer system) to retrieve data for a calendaring entry using a connector. The connector has instructions to permit access to data for a calendaring module. The data for the calendaring module may be stored on at least one of local storage of a first remote computer system or storage at a second remote computer system. In any event, the data is received for the calendaring entry, and one or more descriptors are determined therefrom. A database is queried with a query request using one or more of the descriptors, and a query result is received. The query result is then associated with the calendaring entry in a personalized schedule.

In another embodiment of the invention, data for a calendaring entry is retrieved from data used by a first software application. A contacts database is queried to retrieve contact information for a descriptor, which comprises information concerning a meeting participant. An identifier is associated with the calendaring entry, a communication, sent using a second software application, is received that is associated with the identifier, and a second communication is sent to one or more meeting participants upon receipt of the first communication.

These and other features of the present invention are discussed in greater detail below.

### BRIEF DESCRIPTION OF THE DRAWINGS

The present invention is illustrated by way of example, and not limitation, in the figures of the accompanying drawings, in which:

FIG. 1 is a flowchart for a computer-implemented process of providing a personalized schedule based on calendaring entries in accordance with an embodiment of the present invention;

FIG. 2 depicts an example of a system to provide a personalized schedule based on calendaring entries in accordance with an embodiment of the present invention;

FIG. 3 is a flowchart for a computer-implemented process of providing a personalized schedule based on calendaring entries in accordance with a further embodiment of the present invention;

FIG. 4 is a flowchart for a computer-implemented process of providing a personalized schedule based on calendaring entries in accordance with yet a further embodiment of the present invention;

FIG. 5 depicts an example of a personalized schedule based on calendaring entries in accordance with an embodiment of the present invention; and

FIG. 6 depicts an example of a computer system architecture suitable for use in accordance with the present invention.

### DETAILED DESCRIPTION

Embodiments of the present invention enrich the information provided in a calendaring module to create a personalized schedule for a user. Prior automated calendaring approaches provided minimal information in a user's schedule concerning a meeting or an event. For example, such automated systems may provide information concerning a date, time, participants, and in some cases, a location, for a meeting. The present invention, however, uses entries such as these as the starting point for building an enriched presentation that expands upon and/or amplifies such entries and information.

For example, a personalized schedule for a user, as described in the present application, may be customized to present information that enriches other calendar information presented in the schedule by a calendaring module. Such information may include, but is not limited to, background information on meeting participants, real-time weather information for the meeting location, information concerning companies referenced in the calendaring entry, directions to meeting locations, talking points for a meeting participant, and maps of meeting locations. Information used to create this enriched personalized schedule may be obtained from remote database(s) and/or web service(s) available over a network, such as the Internet. A web service is an interface that may be accessed over a network and executed on a remote computer system.

To collect information used to create an enriched personalized schedule in accordance with the present invention, one or more descriptors may be determined from calendar entry data. These descriptors are obtained in order to request information from one or more databases or web services. As the terms is used in this context, a descriptor is data that may be used to send requests to a web service or database to obtain information relevant to a calendar entry. Accordingly, a descriptor may be a text string that can be inserted into a query request to a database or web service. In one or more embodiments, a database may be accessed by sending requests to a web service.

Descriptors may be determined by scanning the text of a calendar entry and/or data fields thereof. After determining one or more descriptors for the calendar entry, the descriptor may be used to form a request for a descriptor database. A descriptor database is a database that may service requests for information to enrich a calendar entry in a personalized schedule, and provide a response with the available information from the descriptor database. The descriptor database may be accessible through a web service or any other type of interface. The information collected to enrich calendar entry information may be presented in a personalized schedule for a user. In one or more embodiments, the personalized schedule may be sent to a user in an email and/or be made available at the calendaring module. In some cases, the personalized schedule may be accessibly through a client software application running on a computer system, such as a mobile computer system or mobile phone, or through a web browser running one any of these platforms.

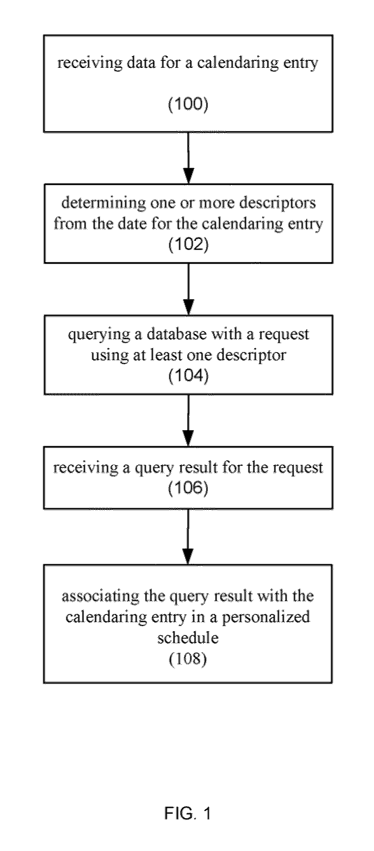

FIG. 1 is a flowchart for a computer-based implementation of a process for providing a personalized schedule based on calendaring entries in accordance with one embodiment of the present invention. Initially, data for a calendaring entry is received using a connector (100). A connector has instructions to permit access to calendaring entry data stored for a calendaring module. The calendaring module may be a software application installed on a computer system or software streamed to a computer system. The calendaring module may access the stored calendar entry data and display the calendar entry information. The connector may use an application programming interface (API) and provide security information in order to gain access to calendaring entry data. In one or more embodiments, data for the calendaring entries is stored locally on a remote computer system that has instructions for executing the calendaring module. The calendaring module may be an application installed on the computer system or the calendaring module may be an application that is streamed to the computer system. The calendaring entry data may be stored in a proprietary format for the calendaring module and the connector may upload calendaring entry data to a personalized schedule module. The personalized schedule module may be software installed or capable of executing on a server and the connector may upload the data to the personalized schedule module on the server. The connector may use push technology to provide the calendaring entry data, pull technology to provide the calendaring entry data, or any combination of push/pull technology.

In one or more embodiments, the connector may be software that executes on a computer system that stores data used by a calendaring module. In another embodiment, the connector may permit access to a calendar database used by the calendaring module. The data used by the calendaring module may be data stored in a database used by the calendaring module and/or metadata for calendaring entries. A database is any collection of data including, but not limited to, a relational database, an object-oriented database, a file system or any other collection of data. Metadata is data about the data stored in a calendar database.

In one or more embodiments, the calendaring entry data stored for the calendaring module may be locally stored on a user's computer system. The data stored locally for the calendaring module may be scheduled to be uploaded to the personalized scheduling module on a regular basis. For example, data for three calendar days may be uploaded from the user's computer system to the personalized schedule module every evening to ensure that the local data on the computer system is captured in the personalized schedule. A user is an authorized user for the calendaring module. The user may include, but is not limited to, a user of the calendaring module, a system administrator, a third-party to a user of the calendaring module that is authorized by the user of the calendaring module, a remote user, or any other authorized user. Data stored locally for the calendaring module may be combined with data stored for the calendaring module in a remote database. The user can specify the priority of data used for the personalized schedule. For example, the user may request that local data stored for the calendaring module be uploaded for calendar entries created by the user and that remotely stored data for the calendaring module be used for calendar entries originated by other users. Those skilled in the art will recognize that any combination of locally stored data and remotely stored data for the calendaring module may be used to create a personalized schedule.

Next, one or more descriptors are determined from data for the calendaring entry (102). The descriptor may be determined by scanning the data for a calendaring entry. In one or more embodiments, the descriptor may be determined by parsing the data for a calendaring entry to identify the one or more descriptors. In another embodiment, the descriptor may be determined from metadata on data stored in a calendar database for calendaring entries. Descriptors may indicate a meeting participant, a meeting participant company name, a meeting participant's title, a meeting location, a meeting status, a meeting time, a meeting participant's interests, or any other data that would provide the ability to query the descriptor database for information to enrich calendar information.

A descriptor database may be queried with a request using at least one of the one or more descriptors (104). The descriptor database may service requests through the use of a web service, a database server, or any other form of interface. The descriptor database may be a database available from a third-party including, but not limited to, LinkedIn™, Hoover's Inc., Dun & Bradstreet Inc., Mapquest™, Google™ Maps, ZoomInfo™ and any other type of web service that provides access to a database. Descriptor databases may be databases associated with customer relationship management (CRM) software, docketing applications, location-based web services, geo-coding web services, weather forecast web services, news source web services, or any other database that has data to enrich calendar entry information. Information such as the user's location may be used to query descriptor databases. For example, the user's default location may be used to query a database for directions to a meeting location. In an embodiment, calendaring entries for the user may indicate the user's location. For example, a calendar entry that has information on a flight that may be taken by a user may indicate the location that should be used for determining directions to a meeting location.

In one or more embodiments, the descriptor may be used to access a contacts database for the user. The contacts database may provide more descriptors that can be used to form a query to a descriptor database. For example, a descriptor may be determined from the calendar entry may be the name “John Doe” and a contacts database for a user may be queried to determine John Doe's location, and John Doe's location may be used as an additional descriptor for a query to a news source in order to provide talking points for an upcoming meeting. The user may indicate in the contacts database that John Doe watches baseball and a news source may be queried to provide information on the latest sport scores to serve as talking points for an upcoming meeting with John Doe. All information pertinent to John Doe requested by the user may be accessible from the personalized schedule.

In one or more embodiments, a determination is made as to which descriptor databases to access. The descriptor databases selected for query may be determined from the type of descriptors determined from the calendaring entry data, user preferences, or any combination thereof.

A result for the request may be received (106). The result may be in the form of a query result set that contains information for the personalized schedule. In one or more embodiments, the result for the request may be retrieved from a cache. For example, the weather information for Chicago may have been retrieved and the weather information may be retrieved from the cache in response to a request.

Next, the result may be associated with the calendaring entry in a personalized schedule (108). The result may be associated with the calendaring entry by incorporating the result into the calendaring entry in a personalized schedule or storing the result with the calendar entry in a database accessed by the calendaring module. In another embodiment, a link to the result may be presented with the calendaring entry in the personalized schedule. The personalized schedule may be provided to the user in an email, web page, or accessed from the calendaring module. The personalized schedule may be a dynamically generated file or portion of a file. The personalized schedule may be displayed or presented to the user in a format that mimics the calendaring module or the user may indicate a desired format for presentation of the personalized schedule.

In some cases, the user may designate when the personalized schedule should be emailed to the user. For example, the user may request that the personalized schedule be emailed to the user every evening at a specific time. Some embodiments may rely on the permissions established in the calendar module for the user may indicate what information in the personalized schedule may be divulged to other meeting participants. For example, the user may designate that the personalized schedule be emailed to a person with full access to his/her calendar stored for the calendaring module. In another embodiment, the user may designate which portions of the personalized schedule are provided to others.

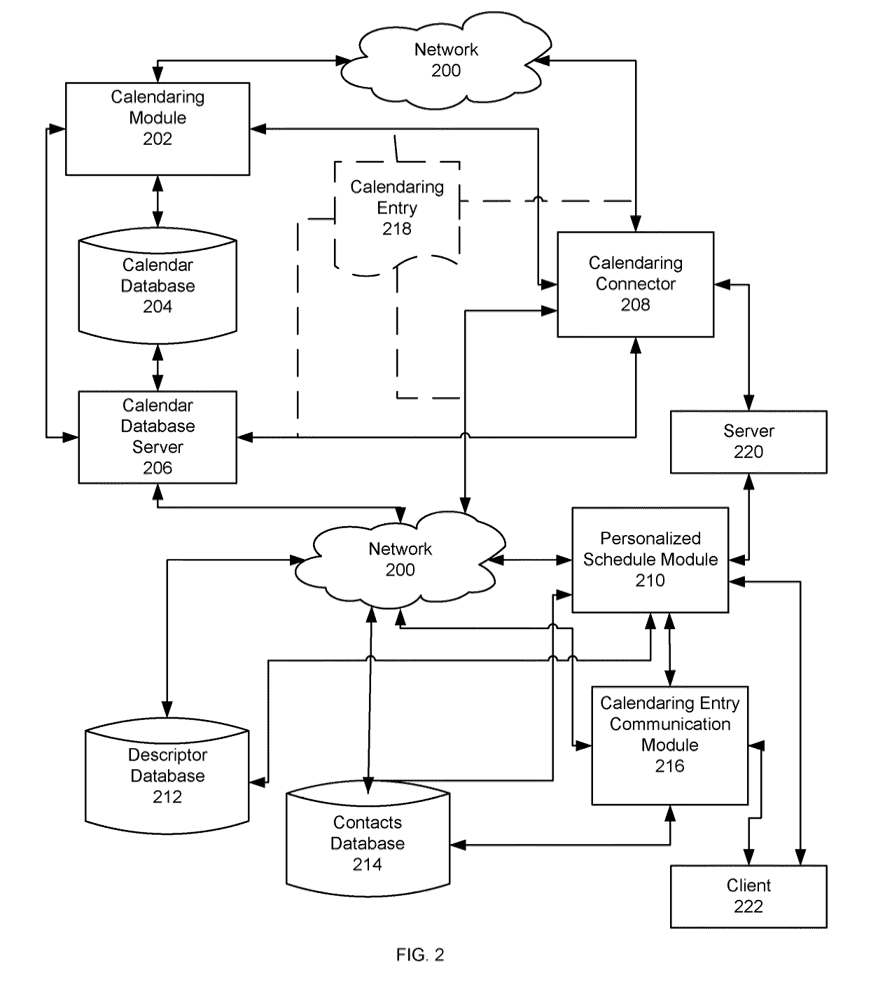

FIG. 2 depicts an example of a system to provide a personalized schedule based on calendaring entries. A network 200 is an infrastructure for sending and receiving signals, communications, messages and/or requests and responses according to one or more designated formats, standards, or protocols. A network 200 may provide for both wired and wireless communication between the various elements of FIG. 2. Embodiments may rely on a network 200 for communication between elements as depicted, including, but not limited to, a calendaring module 202, a calendar database 204, a calendar database server 206, a calendaring connector 208, a personalized schedule module 210, a descriptor database 212, a contacts database 214, and a calendaring entry communication module 216.

Any number of networks and service providers may be used to facilitate communication between the elements of FIG. 2. Examples of available implementations for a network 200 may include, but are not limited to, wireless networks, such as those that use any or all of satellite-based communications, or WiFi- or WiMAX-based communications, and/or hardwired networks, such as those which use fiber optic, coaxial cable, and/or twisted pair communication links. Various communication protocols may be employed to allow for communication between the elements, such as global systems for mobile (GSM), time division multiple access (TDMA), and/or code division multiple access (CDMA), personal communications systems (PCS), WiFi, WLAN, WiMAX, Hyper Text Transfer Protocol (HTTP), internet protocol suites (e.g., Transmission Control Protocol (TCP) and the Internet Protocol (IP)), Voice-over-Internet protocol (VoIP) or other frequently used voice and data communications protocols and standards.

The network 200 may provide the capability for a calendaring connector 208 to receive and/or send calendaring entry data 218 for a calendaring module 202. The calendaring module 202 may be software, hardware, or any combination thereof. The calendaring module 202 may be a standalone application, a streamed application, a web application, hardware, application-specific integrated circuit (ASIC), or any combination thereof. The calendaring connector 208 may upload the calendaring entry data 218 from data accessed by the calendaring module 202. The calendaring entry data 218 may be stored in the calendar database 204 and accessible to the calendaring connector 208 by sending a request and receiving a response with a result from the request to a calendar database server 206. In one or more embodiments, calendaring entry data may be accessible from a computer system that executes instructions for the calendaring module 202. For example, the calendaring module may be an application installed on a computer system, such as an installation of Microsoft's Outlook™ application, and the connector may be an application installed on the same computer system that uploads calendaring entry information from data stored locally on the computer system. In another embodiment, the connector may request calendaring entry data from a calendaring database for a web-based application, such as Google calendar. The calendaring connector 208 may provide security information to access the calendaring entry data stored in the calendar database 204.

The calendaring connector 208 may provide only updates in calendaring entries to the personalized schedule module 210. For example, the calendaring connector may provide only changes to entries or new entries that have been modified/added since the last upload.

The calendaring entry data 218 may be uploaded or received by the personalized schedule module 210. The personalized schedule module 210 may be software and/or hardware, or any combination thereof. For example, the personalized schedule module may be software written in Python and executing on server 220. The personalized schedule module 210 may be a process, a standalone application, a streamed application, a web application, hardware, application-specific integrated circuit (ASIC), or any combination thereof. In one or more embodiments, the personalized schedule module 210 may be installed and executing on a server 220. The personalized schedule may be received or displayed at a client 222 from the personalized schedule module 210 executing on the server 220. Although FIG. 2 depicts a client-server software architecture for enabling providing a personalized schedule based on calendaring entries, there are many computer system architectures that may support implementations described in the present application, including, but not limited to, peer-to-peer architectures, n-tier architectures, use of an application server, and any other distributed system architectures.

In an embodiment, the calendaring connector 208 uploads calendaring entry data for three days to the personalized schedule module 210 at a scheduled time each day. Those skilled in the art will recognize that there are many variations in the scheduled times for an upload as well as the number of calendar days uploaded.

The personalized schedule module 210 may use the calendaring entry data 218 to determine descriptors in order to enrich the calendaring entry information. The personalized schedule module 210 may scan the text or fields of the calendar entry to determine one or more descriptors to query a descriptor database 212. The descriptor is data that may be used to send requests to a web service or database to obtain information relevant to the calendar entry. The descriptor may be a term or text string used in a query sent to the descriptor database 212. In some embodiments, the personalized schedule module 210 may access a contacts database 214 for a user to determine more descriptors relevant to the calendar entry.

Embodiments may employ the use of artificial intelligence to determine descriptors for a particular user. For example, the personalized schedule module may track relevant descriptors for a particular user and how relevant descriptors are determined from the calendar entry data for the user.

After the descriptors are determined the personalized schedule module 210 may send a request to a descriptor database 212 or web service capable of accessing the descriptor database 212. The personalized schedule module 210 may create queries for the descriptor database 212. Although not depicted, the descriptor database 212 queried or accessed with a database server or a web service. The results of the query or request for data from the descriptor database may provide information to enrich the calendaring entry information. The personalized schedule module 210 may create a personalized schedule with the results. The personalized schedule may be emailed or communicated to the user and displayed at a user device or computer system. The user device may allow for data and/or voice communication over a network. User devices may include, but are not limited to, mobile devices, smart phones, cellular phones, Blackberry® devices, personal digital assistances (PDA), mp3 players, laptops, computer systems, multi-mode devices, and other communication devices and elements. In one or more embodiments, the user may view the personalized schedule using a web application accessed via a web browser or client 222 over the network 200.

The client 222 may be an application or a web browser to access a web application to send requests/receive responses from the server 220. The client 222 may send requests/receive response from the server 220 in order to configure the personalized schedule module 210 and calendaring entry communication module 216. For example, the user may use a client 222 application to provide an email address to the personalized schedule module 210 and indicate user preferences for the type of information the user would like to receive to enrich the calendaring entries in the personalized schedule.

In one or more embodiments, the calendaring entry communication module 216 may enrich the calendar entry information by facilitating communication between the meeting participants. The calendaring entry communication module 216 may be software, hardware, or any combination thereof. The calendaring entry communication module 216 may be a process, a standalone application, a streamed application, a web application, hardware, an application-specific integrated circuit (ASIC), or any combination thereof. The calendaring entry communication module 216 may assign an identifier to the calendaring entry. A meeting participant or user may send a communication with the identifier, and the communication may be sent to the meeting participants. The communication may be in any format supported by an element within the system. The Server 222 and 220 may utilize any communication protocol to send and receive communications, such as, for example, General Packet Radio Service (GPRS), Extensible Markup Language (XML), and Short Message Services (SMS) protocols. For example, the user may send a text message with the identifier to the calendaring entry communication module 216. The calendaring entry communication module 216 may receive the text message and forward the communication to meeting participants. The contact information for the meeting participants may be provided in the contacts database 214.

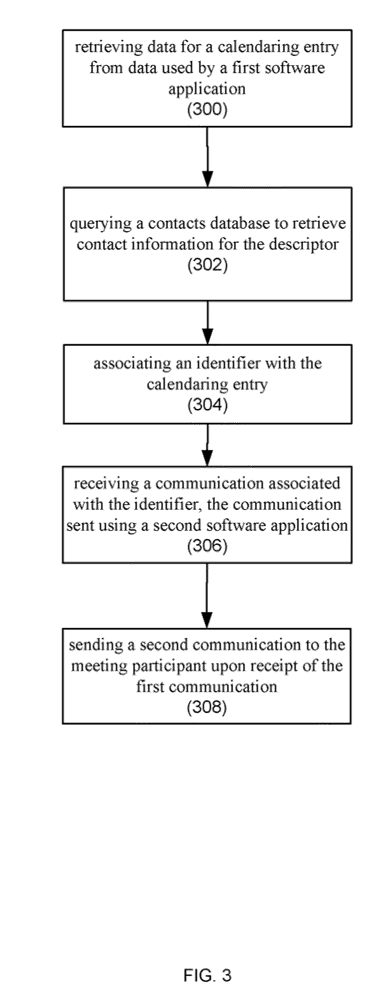

FIG. 3 is a flowchart for an implementation of providing a personalized schedule based on calendaring entries in accordance with the present application. Initially, calendaring entry data stored for a first software application (300) is retrieved. The calendaring connector may be used to retrieve the data stored for the first software application, a calendaring software application. The calendaring entry data may be stored locally on a remote computer system, stored in a database for calendaring software, or any combination thereof.

Next, a contacts database is queried to retrieve contact information for a descriptor (302). The descriptor information may indicate a meeting participant that may receive a communication about the calendar entry. The descriptor may provide a name for the participant, a group name for meeting participants, an alias for one or more meeting participants, or persons may receive information about the meeting in a calendar entry.

An identifier may then be associated with the calendar entry (304). The identifier may be a unique or nearly unique number for the calendar entry. The identifier may be a count of meetings for the user on a particular day and combined with the user's phone number to create a nearly unique number and identifier for the calendar entry. The identifier may be associated with the calendar entry by storing the identifier with the calendar entry. The identifier may be stored in a table with an identifier for the calendaring entry. The identifiers may be stored in a database for the calendaring module, a database associated with the calendaring entry communication module, or any other collection of data.

In an embodiment, a hash function may be used to create an identifier for the calendar entry. A hash function is a mathematical function that creates a nearly unique number with input of some kind of data. The resulting nearly unique number from the hash function may be used as an index to an array or table for the corresponding calendar entry.

A communication may then be received with the identifier associated with the communication (306). The identifier may be included in the communication, such as in a text message. The communication may be sent by a user with a second software application. For example, the user may use text message software to send a text message with the identifier provided in the text message. A link may be provided in the personalized schedule to the text message software and the identifier may be written to the text message when the user selects the link.

Next, a second communication may be sent to the meeting participant upon receipt of the first communication (308). The first communication may be received by the server 222 running the calendaring entry communication module 216, and the calendaring entry communication may look up the calendar entry associated with the identifier included in the first communication. The second communication may be sent to the meeting participants that includes any amount of information provided in the first communication.

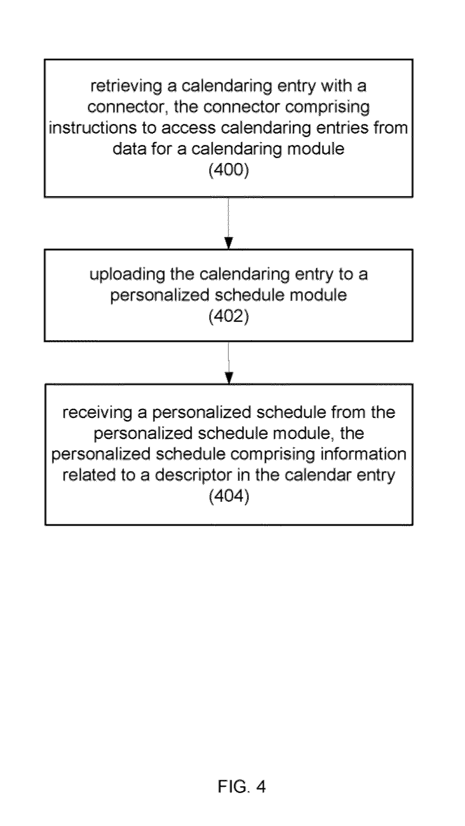

FIG. 4 is a flowchart for an implementation of providing a personalized schedule based on calendaring entries in accordance with the present application. Initially, a connector retrieves data for a calendaring entry (400). The connector may comprise instructions to access the calendaring entry data stored locally on a computer system for a calendaring module. The calendaring module and the connector may run locally on the computer system. The user may have granted permission to the connector installed on the computer system to access the data used by the calendaring module installed on the computer system.

Next, the connector uploads the calendar entry data to a personal schedule module (402). The personal schedule module may be installed on a server and may send/receive requests and responses from the connector. Alternatively, the connector may push the data to the personal schedule module. The connector may be activated to send the data upon startup of the computer system, upon entry of the computer system into a network, and/or upon request of the user.

A personalized schedule may then be received from the personalized schedule module (404). As described above, the personalized schedule may have information that enriches the information provided by the calendaring module on the computer system. The information provided in the personalized schedule may have been obtained with queries using one or more descriptors determined with the calendaring entry data.

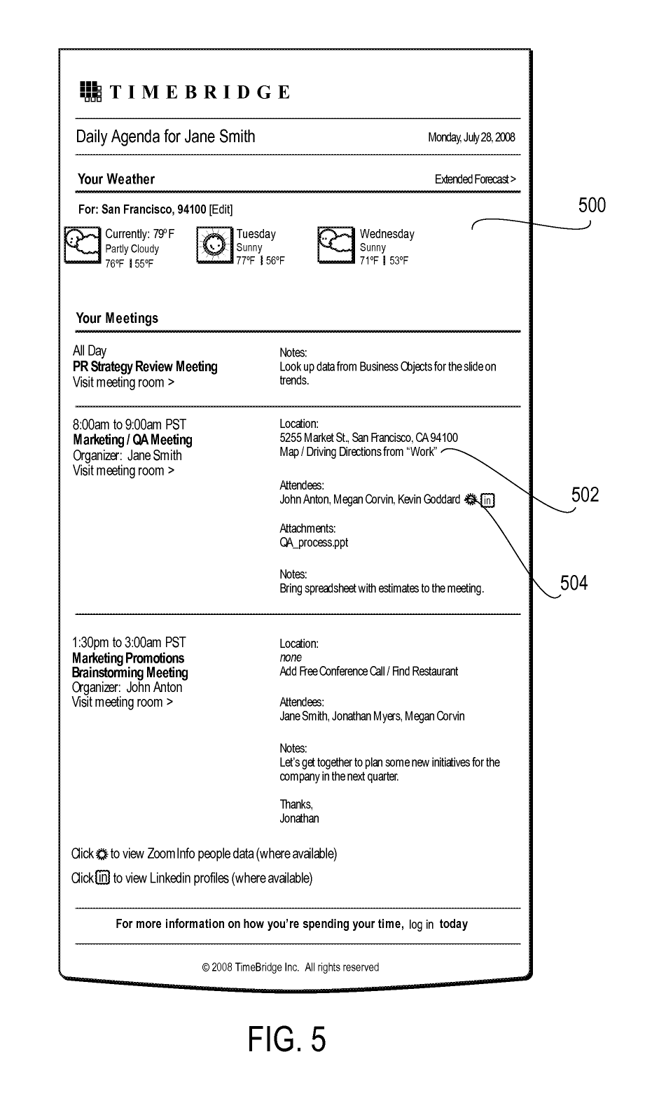

FIG. 5 depicts a personalized schedule based on calendaring entries in accordance with an embodiment of the present application. By way of example, the calendaring entry information for user “Jane Smith” is enriched in FIG. 5 with weather forecast information 500. The calendaring entry for a “Marketing/QA Meeting” is enriched with direction information 502 and information on meeting participant “Kevin Goddard” 504. The databases accessed for information on Kevin Goddard as depicted in FIG. 5 are provided from LinkedIn and ZoomInfo.

### System Architecture

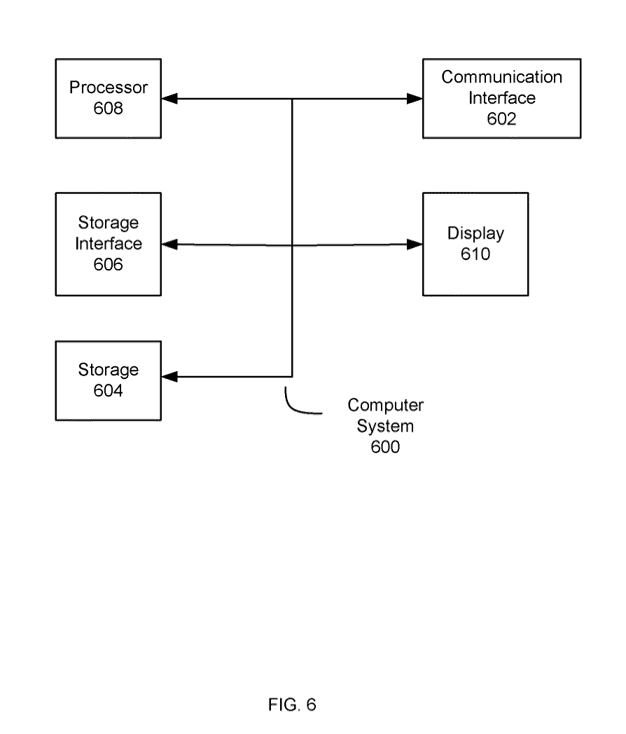

FIG. 6 depicts an embodiment for a system architecture in accordance with the present application. The execution of instructions required to practice the invention may be performed by any number of computer systems 600 as depicted in FIG. 6. As used herein, the term computer system is broadly used to describe any computing device that can store and independently run one or more programs, applications, scripts, or software processes. Implementations of the present invention may have a single computer system 600 or any number of computer systems 600.

Computer systems 600 may communicate with other computer systems/devices with any number of Communication Interface(s) 602. The Communication Interface 602 may provide the ability to transmit and receive signals, such as electrical, electromagnetic or optical signals, that include data streams representing various types of information (e.g. messages, communications, instructions, and data). The Communication Interface 602 may provide an implementation for a communication protocol, such as a network protocol. Instructions may be executed by a Processor 608 upon receipt and/or stored in Storage 604 accessible to the Computer System 600.

Storage 604 may be accessed by the Computer System 600 with a Storage Interface 606. The Computer System 600 may use the Storage interface 606 to communicate with the Storage 604. The Storage Interface 606 may include a bus coupled to the storage and able to transmit and receive signals. Storage 604 may include random access memory (RAM) or other dynamic storage devices, for storing dynamic data and instructions executed by the Processor 608. Any number of Processor(s) 608 may be used to execute instructions for the Computer System 600. Storage may include, but is not limited to, read only memory (ROM), magnetic disks, flash drives, usb drives, and optical disks. In one or more embodiments, a Computer System 600 may be connected to a Display 610 for displaying information to a user.

“Computer usable medium” or “Computer readable medium” refers to any medium that provides information or may be used by a Processor 608. Medium may include volatile and non-volatile storage mediums.

As these and other variations and combinations of the features discussed above can be utilized without departing from the present application as defined by the claims, the foregoing description of the preferred embodiment should be taken by way of illustration rather than by way of limitation of the invention set forth in the claims.

The foregoing description was limited to discussing examples of implementations of the invention but was not intended to be limiting in scope. One of skill in this art will immediately envisage the methods and variations used to implement this invention in other areas than those described in detail. The following claims set forth a number of the embodiments of the invention disclosed with greater particularity.

Various embodiments of the present invention may be implemented with the aid of computer-implemented processes or methods (a.k.a. programs or routines) that may be rendered in any computer language including, without limitation, C#, C/C++, Fortran, COBOL, PASCAL, Ruby, Python, Perl, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

In view of the above, it should be appreciated that some portions of this detailed description are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network.

What is claimed:

1. A method for providing personalized schedule based on calendaring entries, comprising:
sending a request to retrieve data for a calendaring entry using a connector, the connector comprising instructions to permit access to data for a calendaring module;
receiving data for the calendaring entry;
determining one or more descriptors from data for the calendaring entry;
querying a database with a query request using at least one of the one or more descriptors;
receiving a query result for the query request; and
associating the query result with the calendaring entry in a personalized schedule.

2. The method of claim 1, further comprising:
querying a calendaring entry database to retrieve the calendaring entry.

3. The method of claim 1, wherein the connector comprises instructions to access calendaring entries from data stored in a remote database for a calendaring module.

4. The method of claim 1, further comprising:
sending the personalized schedule to the user; and
sending the personalized schedule to a contact of the user.

5. The method of claim 1, wherein the one or more descriptors are determined by scanning the text of the calendaring entry.

6. The method of claim 1, wherein the one or more descriptors are determined from metadata for the calendaring entry.

7. The method of claim 1, wherein at least one of the one or more descriptors is a meeting participant and the query result comprises background information on the meeting participant.

8. The method of claim 1, wherein at least one of the one or more descriptors is a location and the query result comprises directions to the location.

9. The method of claim 1, wherein at least one of the one or more descriptors is a location and the query result comprises a weather forecast for the location.

10. The method of claim 1, further comprising:
retrieving data for the calendaring entry from data used by a first software application;
querying a contacts database to retrieve contact information for the descriptor, the descriptor comprising information on a meeting participant;
associating an identifier with the calendaring entry;
receiving a communication associated with the identifier, the communication sent using a second software application; and
sending a second communication to the meeting participant upon receipt of the first communication.

11. A method for providing personalized schedule based on calendaring entries, comprising:
sending a request to retrieve data for a calendaring entry using a connector, the connector comprising instructions to permit access to a remote database to retrieve data stored for a calendaring module;
receiving data for the calendaring entry;
determining one or more descriptors from data for the calendaring entry;
querying a database with a query request using the one or more descriptors;
receiving a query result for the query request; and
associating the query result with the calendaring entry in a personalized schedule.

12. The method of claim 11, further comprising:
querying a calendaring entry database to retrieve the calendaring entry.

13. The method of claim 11, wherein the connector comprises instructions to access calendaring entries from data stored locally for a calendaring module.

14. The method of claim 11, further comprising:
sending the personalized schedule to the user; and
sending the personalized schedule to a contact of the user.

15. The method of claim 11, wherein the one or more descriptors are determined by scanning the text of the calendaring entry.

16. The method of claim 11, wherein the one or more descriptors are determined from metadata for the calendaring entry.

17. The method of claim 11, wherein at least one of the one or more descriptors is a meeting participant and the query result comprises background information on the meeting participant.

18. The method of claim 11, wherein at least one of the one or more descriptors is a location and the query result comprises directions to the location.

19. The method of claim 11, wherein at least one of the one or more descriptors is a location and the query result comprises a weather forecast for the location.

20. A method for providing personalized schedule based on calendaring entries, comprising:
retrieving data for a calendaring entry from data used by a first software application;
querying a contacts database to retrieve contact information for a descriptor, the descriptor comprising information on a meeting participant;
associating an identifier with the calendaring entry;
receiving a communication associated with the identifier, the communication sent using a second software application, and
sending a second communication to one or more meeting participants upon receipt of the first communication.

21. A method for providing personalized schedule based on calendaring entries, comprising:
retrieving data for a calendaring entry with a connector, the connector comprising instructions to permit access to data for a calendaring module stored locally on a computer system;
uploading the calendaring entry to a personalized schedule module; and
receiving a personalized schedule from the personalized schedule module, the personalized schedule comprising information related to a descriptor in the calendar entry.
